(19) United States
(12) Patent Application Publication
(10) Pub. No.: US 2012/0004870 A1
(43) Pub. Date: Jan. 5, 2012

(54) METHOD AND DEVICE FOR MONITORING A PHOTOVOLTAIC UNIT

(75) Inventor: Jörg-Werner Ney, Schwalbach (DE)

(73) Assignee: Siemens Aktiengesellschaft, Munchen (DE)

(21) Appl. No.: 13/201,909

(22) PCT Filed: Feb. 12, 2010
(86) PCT No.: PCT/EP10/51797

§ 371 Date: Sep. 21, 2011

(30) Foreign Application Priority Data
Feb. 17, 2009 (DE) 10 2009 009 050.9

(51) Int. Cl. G06F 19/00

(52) U.S. Cl. 702/60

(57) ABSTRACT

In a method and a device (10), for monitoring at least one unit part of a photovoltaic unit (20), determination of a temperature-compensated daily solar irradiated energy is carried out and a comparison of the determined temperature-compensated power ratio with a power ratio set value is carried out for the at least one plant part. A comparison of the power ratios determined on differing days or different times of year can be achieved for the photovoltaic unit (20).

### CROSS-REFERENCE TO RELATED APPLICATIONS

This application is a U.S. National Stage Application of International Application No. PCT/EP2010/051797 filed Feb. 12, 2010, which designates the United States of America, and claims priority to German Application No. 10 2009 009 050.9 filed Feb. 17, 2009, the contents of which are hereby incorporated by reference in their entirety.

### TECHNICAL FIELD

The invention relates to a method and a device for monitoring at least one unit part of a photovoltaic unit or a complete photovoltaic unit.

### BACKGROUND

A photovoltaic unit having a power in the region of several megawatts is a power station in which the radiation energy of the sun is converted into electrical energy in the form of direct current by means of photovoltaic cells. A photovoltaic cell is used as a converter of the radiation energy by using the photovoltaic effect. Owing to the low electrical voltage of a single photovoltaic cell (approx. 0.5 volts) a plurality of cells are combined to form photovoltaic modules. A plurality of photovoltaic modules is wired to form strings connected in series.

A photovoltaic unit therefore conventionally comprises a number of photovoltaic modules which each comprise a large number of photovoltaic cells that are electrically wired to each other. To feed the direct current generated by the photovoltaic unit into the public grid the direct current must be converted into alternating current optionally by means of inverters. To connect individual photovoltaic modules to each other and/or to the public grid and/or a load at least one electrical line system, optionally also coupling cabinets and/or generator cabinets in which photovoltaic modules are electrically combined, is provided.

Photovoltaic units with a power in the region of several megawatts take up a large contact area which is usually greater than one square kilometer. Photovoltaic units are frequently also highly branched with optionally free areas, which are spaced apart from each other and which are subject to high solar radiation, for erecting photovoltaic modules comprising a large number of photovoltaic cells being used. The distance between individual photovoltaic modules of a photovoltaic unit can be more than a kilometer. The geometry of a photovoltaic unit and the distances between individual photovoltaic modules depend on the available plot area(s). The arrangement and number of operational buildings are preferably selected such that the distances of the individual photovoltaic modules from operational buildings are as uniform as possible and the current-carrying lines between photovoltaic modules and operational buildings are constructed so as to be as alike as possible or of similar length. The current-carrying lines are designed so as to be up to a length of approximately 1,200 m at most, preferably not longer than approximately 500 m.

Such photovoltaic units are usually not occupied by personnel, so a defect in a part of the extensive photovoltaic unit, whether due to a number of defective photovoltaic cells and/or due to one or more defective photovoltaic module(s) and/or due to one or more flaws in electrical lines in the line system of the unit and/or due to a defect at one or more inverter(s), often remains undetected for a relatively long period resulting in reduced unit production. Monitoring all zones of an extensive photovoltaic unit, in particular by means of operating personnel, requires high financial and/or technical expenditure and is therefore uneconomical.

In order to still allow monitoring of photovoltaic units various self-diagnosis systems are already used which are listed below.

A first known self-diagnosis system is based on the fact that the total currents of individual photovoltaic modules, which are combined at an inverter, are compared with each other. As soon as a total current is detected as being too low compared with the further total currents an error message is output. Error messages frequently occur during the course of the day since, owing to partial shading of the photovoltaic unit due to changing cloud cover, a deviation of one or more total currents from a total current produced in a different part of the unit that is subject to greater sunshine occurs again and again.

A second known self-diagnosis system is based on the fact that the instantaneous powers of different inverters are compared with each other. As soon as an instantaneous power is detected as being too low compared with the further total powers an error message is output. However, the same problem occurs here as in the first self-diagnosis system.

A third known self-diagnosis system is based on the formation of a ratio between the instantaneously attained power and the theoretically attainable power of the photovoltaic unit on the basis of a measured solar radiation power. One problem in this connection is that, owing to changing environmental conditions, in particular changing wind speeds and/or weather-induced and/or seasonal solar radiation, it is not possible to compare power ratios determined on different days of the year.

A fourth known self-diagnosis system is based on the fact that standardized energies of different inverters are compared with each other. However, the same problem occurs here as with the third self-diagnosis system.

The publication “Überwachung/Monitoring von Photovoltaikanlagen”[Monitoring of photovoltaic units], M. D'Souza, L. Herzog, Bulletin SEV/VSE 10/94, p. 27 -28, describes one concept for a monitoring apparatus to safeguard production of photovoltaic units.

The publication “Analyse des Betriebsverhaltens von Photovoltaikanlagendurch normierte Darstellung von Energieeintrag and Leistung”[Analysis of the operating behavior of photovoltaic units by standardized representation of energy input and power], H. Häberlein, C. Beutler, Bulletin SEV/VSE 4/95, p. 25-33, describes one possibility of comparing photovoltaic units of different sizes and local attachment to each other.

However, experiences from photovoltaic units in the order of magnitude of several megawatts have shown that partial shading of the photovoltaic unit due to cloud cover produces too many false error messages in an automated monitoring system if the quotient of actual value to desired value on the power level or on power mean values with short time intervals are compared with a unit-specific reference value.

### SUMMARY

According to various embodiments, a method and a device can be provided, which are improved by contrast, for monitoring at least one unit part of a photovoltaic unit.

According to an embodiment, a method for monitoring at least one unit part of a photovoltaic unit, may comprise the following steps:
determining a temperature-compensated daily solar radiation energy H_{daycomp} in Wh/m² of the at least one unit part, wherein

$${H}_{daycomp} = {\int }_{Sunrise}^{Sunset} G * ( 1 - ( T - 25 K ) * {γ}_{{P}_{MPP} ( T )} ) d t$$

where

G=solar radiation power in W/m²,

T=temperature of the at least one unit part in K,

γ_{P}_{_{MMP}}_{(T)}=temperature coefficient of at least one photovoltaic module of the at least one unit part in 1/K at maximal power,
determining a temperature-compensated power ratio PR_{daycomp} in %, wherein

$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$

where

E_{day}=daily energy of the at least one unit part in kWh,

Pₜₕₑₒ=maximum possible power in kW of the photovoltaic unit with standard test conditions, and
comparing the determined temperature-compensated power ratio PR_{daycomp} with a power ratio desired value for the at least one unit part.

According to a further embodiment, the at least one unit part may comprise at least one photovoltaic module having a large number of photovoltaic cells and/or comprising at least one inverter is chosen. According to a further embodiment, for determining the daily energy E_{day} a contactless direct current measurement can be carried out and an instantaneous current signal determined in the process is multiplied by a direct voltage instantaneously measured at the at least one unit part. According to a further embodiment, the determination of the temperature-compensated power ratio PR_{daycomp} and the comparison between the determined temperature-compensated power ratio PR_{daycomp} and the power ratio desired value may be automatically carried out for the at least one unit part. According to a further embodiment, the comparison between the determined temperature-compensated power ratio PR_{daycomp} and the power ratio desired value for the at least one unit part may be only carried out if a fixed minimal value is attained or exceeded for H_{daycomp}. According to a further embodiment, at least one warning signal can be output in the case of a negative deviation of the determined temperature-compensated power ratio PR_{daycomp} from the power ration desired value for the at least one unit part.

According to another embodiment, a device for carrying out the method may comprise:—at least one first apparatus for determining a temperature T of the at least one unit part,—at least one second apparatus for determining a solar radiation power G in at least one unit part,—at least one third apparatus for determining values for calculating a daily energy E_{day} of the at least one unit part, and—at least one fourth apparatus for calculating the daily energy E_{day} of the at least one unit part and/or for calculating a temperature-compensated daily solar radiation energy H_{daycomp} of the at least one unit part and/or for calculating a temperature-compensated power ratio PR_{daycomp} of the at least one unit part and/or furthermore for comparing the temperature-compensated power ratio PR_{daycomp} with a power ratio desired value for the at least one unit part.

According to a further embodiment of the device, the at least one fourth apparatus can be set up to carry out the following calculations:—determining the temperature-compensated daily solar radiation energy H_{daycomp} in Wh/m², wherein

$${H}_{daycomp} = {\int }_{Sunrise}^{Sunset} G * ( 1 - ( T - 25 K ) * {γ}_{{P}_{MPP} ( T )} ) d t$$

where

G=solar radiation power in W/m²,

T=temperature of the at least one unit part in K,

γ_{P}_{_{MPP}}_{(T)}=temperature coefficient in 1/K of at least one photovoltaic module of the at least one unit part at maximal power, and
determining a temperature-compensated power ratio PR_{daycomp} in %, wherein

$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$

where

E_{day}=daily energy of the at least one unit part in kWh,

Pₜₕₑₒ=maximum possible power in kW of the photovoltaic unit with standard test conditions, and
comparing the determined temperature-compensated power ratio PR_{daycomp} with a power ratio desired value for the at least one unit part. According to a further embodiment of the device, furthermore there may be at least one fifth apparatus for outputting at least one warning signal in the case of a negative deviation of the determined temperature-compensated power ratio PR_{daycomp} from the power ratio desired value.

According to a further embodiment of the device, the at least one first apparatus and the at least one second apparatus may be associated with the photovoltaic unit. According to a further embodiment of the device, the device may comprise a third apparatus respectively for determining values for calculating a daily energy E_{day} are associated with an inverter of the photovoltaic unit. According to a further embodiment of the device, the at least one fourth apparatus can be provided by at least one arithmetic unit. According to a further embodiment of the device, remote monitoring of the photovoltaic unit can be carried out by means of the at least one fourth device and/or the at least one fifth apparatus. According to a further embodiment of the device, the first and/or second apparatus(es) can be installed at two or more points of the photovoltaic unit for monitoring a photovoltaic unit with a power in the region of several megawatts.

According to yet another embodiment, a device as described above can be used while carrying out a method as described above as a self-diagnosis system for detecting at least one defect in at least one unit part of a photovoltaic unit or an entire photovoltaic unit.

### BRIEF DESCRIPTION OF THE DRAWINGS

FIGS. 1 and 2 are intended to describe the measured value acquisition and the construction of a device by way of example. In the figures:

FIG. 1 shows a graph which illustrates the measured values of a photovoltaic unit detected over a day; and

FIG. 2 shows a schematic diagram of a device for monitoring at least one unit part of a photovoltaic unit.

### DETAILED DESCRIPTION

According to various embodiments, the method for monitoring at least one unit part of a photovoltaic unit may comprise the following steps:
determining a temperature-compensated daily solar radiation energy H_{daycomp} in Wh/m² of the at least one unit part, wherein

$${H}_{daycomp} = {\int }_{Sunrise}^{Sunset} G * ( 1 - ( T - 25 K ) * {γ}_{{P}_{MPP} ( T )} ) d t$$

where

G=solar radiation power in W/m²,

T=temperature of the at least one unit part in K,

γ_{P}_{_{MPP}}_{(T)}=temperature coefficient in 1/K of at least one photovoltaic module of the at least one unit part at maximal power,
determining a temperature-compensated power ratio PR_{daycomp} in %, wherein

$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$

where

E_{day}=daily energy of the at least one unit part in kWh,

Pₜₕₑₒ=maximum possible power in kW of the photovoltaic unit with standard test conditions, and
comparing the determined temperature-compensated power ratio PR_{daycomp} with a power ratio desired value for the at least one unit part.

A temperature coefficient γ_{P}_{_{MPP}} of a photovoltaic module in 1/K at maximum power is frequency given in a manufacturer's data sheet relating to a photovoltaic module as constants over a certain temperature range. This temperature range frequently comprises all temperatures to which a photovoltaic module is conventionally exposed. With regard to highly efficient photovoltaic modules which in certain temperature ranges can have different temperature coefficients γ_{P}_{_{MPP}}, the formula takes into account the temperature dependency of the temperature coefficient γ_{P}_{_{MPP}}_{(T)} of the temperature T of the at least one unit part.

In contrast to conventional systems and methods, according to various embodiments, it is the radiation power that is temperature-corrected on the basis of the temperature behavior of the photovoltaic module used, and not the solar generator power. The temperature-corrected radiation power is added up to give the temperature-corrected daily radiation energy. The daily basis is an empirical value which has shown that the differences from the cloud-induced partial shading of a photovoltaic unit are conventionally sufficiently equalized.

The value Ptheo is added up from power figures relating to photovoltaic modules used in the photovoltaic unit which apply under standard test conditions. Standard test conditions here are taken to be a solar radiation power of 1,000 W/m², a temperature of the photovoltaic module of 25° C. and furthermore a relative air mass figure AM=1.5, where AM represents a thickness of the atmosphere penetrated by the sunlight.

According to other embodiments, the device for carrying out the method may comprise the following:
at least one first apparatus for determining a temperature T of the at least one unit part,
at least one second apparatus for determining a solar radiation power G in at least one unit part,
at least one third apparatus for determining values for calculating a daily energy E_{day} of the at least one unit part, and
at least one fourth apparatus for calculating the daily energy E_{day} of the at least one unit part and/or for calculating a temperature-compensated daily solar radiation energy H_{daycomp} of the at least one unit part and/or for calculating a temperature-compensated power ratio PR_{daycomp} of the at least one unit part and/or furthermore for comparing the temperature-compensated power ratio PR_{daycomp} with a power ratio desired value for the at least one unit part.

A use of a device according to various embodiments may carry out a method according to various embodiments, as a self-diagnosis system for detecting at least one defect in at least one unit part of a photovoltaic unit or of an entire photovoltaic unit is ideal.

The method and the device according to various embodiments allow extensive compensation of changing environmental influences, so it is possible to compare certain power ratios on different days or at different times of year, wherein the production of a photovoltaic unit or a unit part of the photovoltaic unit can be continuously tracked over a long period. Values of the unit parts can be compared with typical desired values for the respective unit part in addition to unit parts being compared with each other as previously.

A desired value typical for a unit part or the entire photovoltaic unit deviates from 100% by the losses in lines or other components of the unit which are to be regarded as approximately constant. Since the comparison is not made with the aid of instantaneous values of the generated current and power, but on the basis of daily values, environmental influences occurring over the day, such as changing cloud cover, are canceled out and fewer error messages are produced.

It has been found that the changing environmental influences manifest themselves in particular in a noticeable change in the ambient temperature of the photovoltaic unit. The temperature T of a photovoltaic module of a unit part substantially depends on the solar radiation, the ambient temperature and the wind situation. The effect of the solar radiation on the temperature T of a photovoltaic module can be broken down further into a direct effect owing to heating due to absorption of the solar radiation and an indirect effect owing to heating of the semiconductor material due to a current flow in the semiconductor material corresponding to the solar radiation.

The efficiency of a photovoltaic cell changes with changes in temperature as a function of the temperature coefficient γ_{P}_{_{MPP}}_{(T)}. Two opposed effects are reflected in the temperature coefficient γ_{P}_{_{MPP}}_{(T)}. With an increase in temperature T an increase in the internal resistance of the semiconductor material of the photovoltaic cells occurs on the one hand and an increase in the intrinsic conductivity of the semiconductor material of the photovoltaic cells occurs on the other hand. The temperature coefficient γ_{P}_{_{MPP}}_{(T)} of a photovoltaic cell is conventionally in a range from approx. −0.43%/K to −0.5%/K at maximum power. The power of a photovoltaic cell reduces accordingly by way of example with an increase in the temperature T of a photovoltaic module by 30 K by approximately 12.9 to 15%.

The compensation of the effect of the environment, in particular of the ambient temperature, wind strength and solar radiation, on the power generated by photovoltaic cells that can be achieved by means of the method and the device according to various embodiments allows the changes in the performance of unit parts of a photovoltaic unit comprising at least one photovoltaic module to be detected immediately. Only the changes actually based on a defect in the photovoltaic unit are detected and the error messages based on a change in the environmental influences are avoided.

A unit part preferably comprises at least one photovoltaic module and at least one inverter.

A use of the device or of the method according to various embodiments in one or a plurality of unit parts respectively of a photovoltaic unit allows self-diagnosis of the unit, it being possible for one defect to be detected and optionally regionally localized and directly associated with a unit part. As a result the need for checking and optionally repair of the affected unit part can be quickly be detected and consequently be carried out quickly and simply in situ. Increased production and much reduced maintenance expenditure result for the photovoltaic unit owing to the prompt detection of actual defects in the photovoltaic unit and the fact that error messages relating to the state of the unit practically no longer occur.

In a photovoltaic unit with a power in a range of several megawatts first and/or second apparatus(es) of the device are preferably installed at more than one, in particular at more than two, locations.

In principle, detection of the temperature T by means of a single first apparatus on a photovoltaic module in a unit part and detection of the solar radiation power G by means of a second apparatus in a unit part, in particular for one photovoltaic module, is sufficient if the respective unit part is also representative of all other unit parts, in particular photovoltaic modules, of the photovoltaic unit with regard to its temperature and solar radiation power G. However, it is often the case that owing to the local conditions a single measurement of the temperature T and a one-off detection of the solar radiation power G cannot be transferred to all other unit parts, in particular photovoltaic modules. In this case it is advantageous to equip all unit parts, in particular photovoltaic modules, whose temperatures T can deviate significantly from one another, separately with a respective first apparatus for measurement of the temperature T. It is also advantageous to equip all unit parts, in particular photovoltaic modules, for which the solar radiation can differ significantly, with a respective second apparatus for determining the solar radiation power G. A significant difference in the temperature T or in the solar radiation occurs in particular if the result for H_{daycomp} is falsified by more than approximately 1.5%.

The at least one first apparatus of the device for determining a temperature T of a photovoltaic module of the at least one unit part is preferably directly locally associated with the photovoltaic unit. A digital thermometer or a temperature sensor with standardized analog signal is used in particular as a first apparatus to determine the temperature T in the region of the photovoltaic unit or one of its unit parts. A first apparatus is preferably located on a photovoltaic module, in particular in the form of a PT 100-temperature sensor on the back, i.e. the side facing away from the solar radiation, of a photovoltaic module. The measured temperatures T, optionally per measuring station, are transmitted to the at least one fourth apparatus of the device.

It has proven expedient if one first apparatus each is present for each photovoltaic module comprising a large number of photovoltaic cells of the photovoltaic unit or if one first apparatus each is present for each string of the photovoltaic unit. As a result certain positions of photovoltaic modules on mountain slopes can be sufficiently taken into account, by way of example different temperatures of a module on a mountain oriented to the east or west compared with a module on a mountain slope oriented to the south, etc.

For the method it has proven expedient if the at least one unit part comprising at least one photovoltaic module having a large number of photovoltaic cells and/or comprising at least one inverter is chosen. However, the entire photovoltaic unit may also be monitored by means of the method, in particular if units with a low surface area of up to 0.5 km² are involved.

The at least one second apparatus for determining the solar radiation power G of the at least one unit part is preferably locally directly associated with the photovoltaic unit, in particular a photovoltaic module. For determining the solar radiation power G a second apparatus preferably comprises at least one solar radiation sensor, in particular having standardized analog signal. Individual values of the solar radiation power G are detected over a certain period by means of a solar radiation sensor and transmitted to the at least one fourth apparatus of the device.

The at least one third apparatus for determining values for calculating the daily energy E_{day} preferably comprises at least one, in particular contactlessly operating, direct current measuring device and at least one direct voltage measuring device. At least one third apparatus respectively is preferably associated with each inverter of the photovoltaic unit.

Inverters having one or more DC input(s), in particular four DC inputs, are preferably used. With an inverter having only one DC input, one direct current and one direct voltage measurement in particular are carried out. With a particularly preferred inverter having four DC inputs, four direct current measurements and one direct voltage measurement in particular are carried out. The detected current and voltage signals are transmitted to the at least one fourth apparatus of the device. There the products of current and voltage determined over a day are added up for the daily energy E_{day}.

The at least one fourth apparatus of the device, by way of example an arithmetic unit such as a PC, is in particular equipped with software which allows calculation of the values for E_{day} and/or H_{daycomp} and/or PR_{daycomp}, and optionally for comparison of instantaneous values for PR_{daycomp} with earlier measured values for PR_{daycomp}. The values for the power ratio desired value and Pₜₕₑₒ and γ_{P}_{_{MPP}}_{(T)}.are stored in the at least one fourth apparatus for this purpose.

Determination of E_{day}, furthermore of the temperature-compensated power ratio PR_{daycomp} and the comparison between the determined temperature-compensated power ratio PR_{daycomp} and the power ratio desired value for the at least one unit part comprising at least one photovoltaic module is preferably automatically carried out by means of the at least one fourth apparatus. Alternatively the calculations can of course also be carried manually or semi-automatically out by photovoltaic unit operating personnel by means of the at least one fourth apparatus. A single or several fourth apparatus(es), in particular arithmetic units, may be used for detection of the measured values transmitted by the first, second and third apparatus(es). The calculations can be carried out by means of a single fourth apparatus, in particular on the same arithmetic unit.

The comparison between the determined temperature-compensated power ratio PR_{daycomp} and the power ratio desired value for the at least one unit part is only carried out in particular if a fixed minimum value is achieved or exceeded for H_{daycomp}. The result of this is that the above-mentioned losses occurring in the photovoltaic unit, such as power losses, losses at transformers or losses at inverters, can be regarded as being approximately constant.

Within the framework of commissioning of a photovoltaic unit the power ratio desired value is fixed with respect to the perfectly functioning unit or at least a unit part. The losses that occur are deducted from a theoretically possible power ratio value that can be calculated on the basis of the power figures of the existing photovoltaic modules, which losses are based for example on the geometry of the unit and manifest themselves primarily in the form of power losses. The losses can be up to 3% in practice. Tolerances in the measured value detection, tolerances in the actual powers of the photovoltaic modules, losses in the region of the inverters, adjustment losses, etc. also contribute to this as well, however, in addition to the power losses. As security another 1 to 2% is conventionally deducted from the power ratio value calculated therefrom and attainable with the unit or a unit part in order to compensate the dynamics which result owing to different climatic conditions. The result forms the power ratio desired value.

If measurements are to be taken even on days with particularly low solar radiation, the value for the power ratio desired value must be corrected since the occurring losses should no longer be considered to be constant here.

Preferably at least one warning signal is output with a negative deviation of the determined temperature-compensated power ratio PR_{daycomp} from the power ratio desired value for the at least one unit part. This can take place by way of a visual and/or an acoustic warning signal.

The unit part which represents the cause of the warning signal is preferably also displayed and/or named.

The device according to various embodiments preferably also comprises at least one fifth apparatus for outputting the at least one warning signal in the event of a negative deviation of the determined temperature-compensated power ratio PR_{daycomp} from the power ratio desired value. The fifth apparatus is in particular a screen or the like for visual output and/or a horn or the like for acoustic output of the warning signal.

However, a warning signal can alternatively or additionally also be generated by means of the at least one fourth apparatus.

It is particularly preferred if remote monitoring of the photovoltaic unit can be carried out by means of the at least one fourth apparatus and/or the at least one fifth apparatus. For this purpose the at least one fourth apparatus and/or the at least one fifth apparatus is/are installed so as to be physically separate from the photovoltaic unit, so a presence of an operator in situ in the region of the photovoltaic unit is unnecessary. This saves costs for operating personnel and still allows quick intervention in the event of defects in the unit.

The following example is intended to describe the according to various embodiments for a photovoltaic unit having a maximum power Pₜₕₑₒ of 15 MW in more detail. The unit spans an area of approximately 1 km². The photovoltaic modules number 69,340 and have a mean power of approximately 216.5 W per module. There are also 36 inverters having 400 kVA power and 4 DC inputs as well as six inverters having 100 kVA power and a DC input with which the modules are associated. Each of the 150 DC inputs is associated on average with 23 so-called strings in a parallel circuit, with each string consisting of 20 photovoltaic modules connected in series. The photovoltaic unit is located on a flat rectangular site with an area of 1.2 km×0.8 km. There are two operational buildings in which half of the present inverters are located respectively.

Two first apparatuses for measurement of the temperature T are also installed in the region of the photovoltaic unit in the form of digital temperature sensors. There are also two second apparatuses for detecting the solar radiation power G in the region of the unit. One third apparatus respectively is installed per inverter. Each third apparatus comprises one direct voltage measuring device respectively and per DC input of the inverter one measurement device each for contactless direct current measurement of the total current generated by the photovoltaic modules.

### EXAMPLE

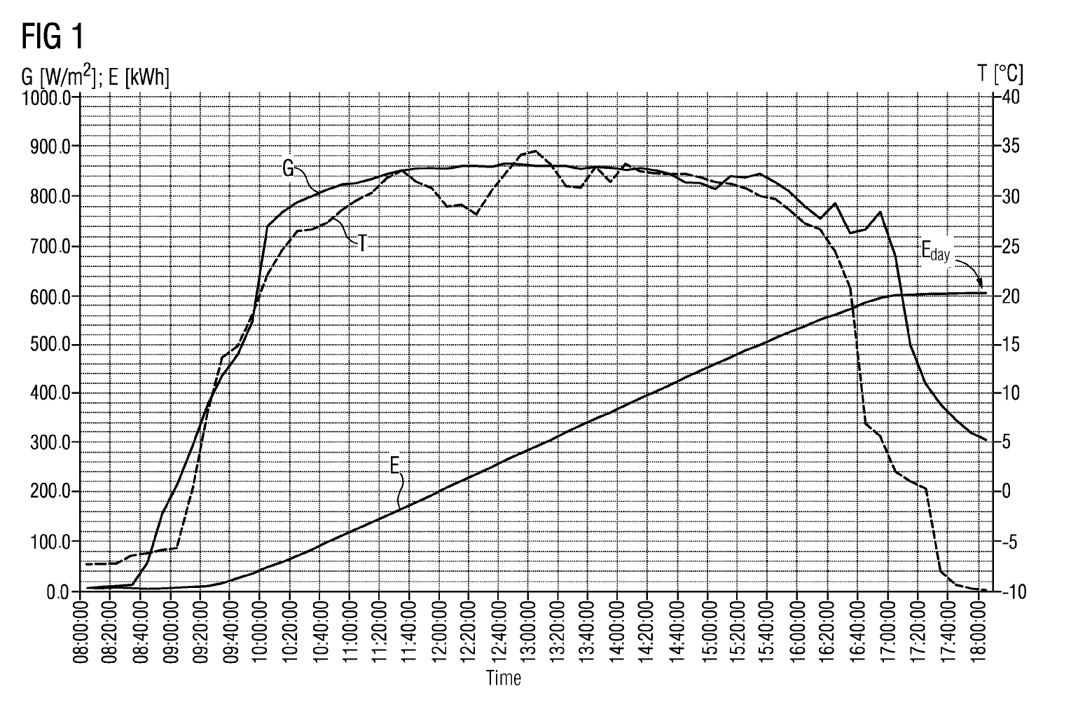

A calculation of the temperature-compensated daily solar radiation energy H_{daycomp} of a unit part is made which is associated with one of the two operational buildings:

$$\begin{matrix}{H}_{daycomp} = {\int }_{Sunrise}^{Sunset} G * ( 1 - ( T - 25 K ) * {γ}_{{P}_{MPP} ( T )} ) d t \\ = 6220 Wh / {m}^{2}\end{matrix}$$

where γ_{P}_{_{MPP}}_{(T)}=0.0045 l/K in the occurring temperature range; and measured values according to FIG. 1 for G, E_{day} and T

Determination of the temperature-compensated power ratio PR_{daycomp} now takes place:

$${PR}_{daycomp} = \frac{( \frac{{E}_{day}}{{P}_{theo}} )}{( \frac{{H}_{daycomp}}{1000 \frac{W}{{m}^{2}}} )} * 100 \% = 95.6 \%$$

where

E_{day}=599.35 kWh, Pₜₕₑₒ=100.8 kW, H_{daycomp}=6,220 Wh/m²

A comparison of the determined temperature-compensated power ratio PR_{daycomp} with a power ratio desired value for the selected unit part is then made:

PR_{daycomp}=95.6%

Power ratio desired value=92%

Case 1: PR_{daycomp}≧power ratio desired value

If the existence of case 1 is determined this is categorized as full functionality of the selected unit part.

Case 2: PR_{daycomp}<power ratio desired value

If the existence of case 2 is determined a defect is assumed for the selected unit part and a warning message output which identifies the unit part and activates checking and optionally maintenance or repair of the unit part by operating personnel.

Case 1 exists for the selected unit part here, so the photovoltaic unit in the monitored unit part is not checked.

FIG. 1 shows a graph which illustrates the measured values of a photovoltaic unit detected over a day between 08:00 and 18:00. The temperature of a photovoltaic module T in ° C. (yet to be converted into Kelvin), the sum of the energy values E of the photovoltaic module in kWh, which produce the daily energy E_{day} in kWh at 18:00, and the solar radiation power G in W/m² of a unit part are shown.

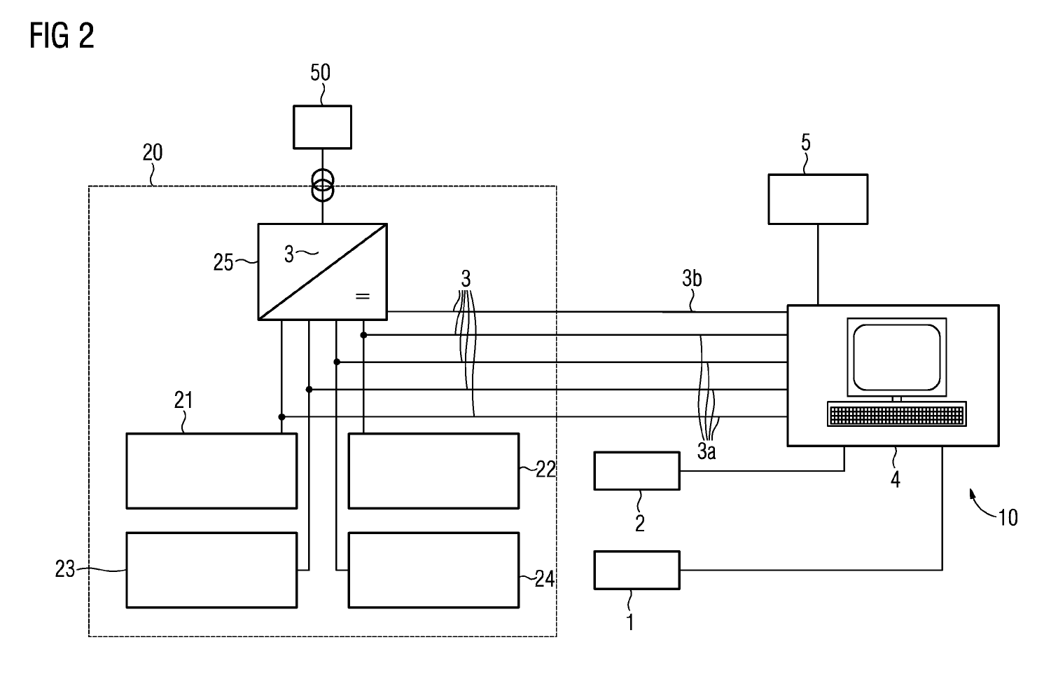

FIG. 2 shows a schematic diagram of a device 10 for monitoring at least one unit part of a photovoltaic unit 20. The unit part of the photovoltaic unit 20 comprises the photovoltaic modules 21, 22, 23, 24 which are connected to an inverter 25. Direct current generated in the photovoltaic modules 21, 22, 23, 24 is converted into alternating current in the inverter 25 and fed into a grid 50. The device 10 comprises a first apparatus 1 in the form of a temperature sensor for detecting the temperature T of the photovoltaic modules 21, 22, 23, 24. The device 10 also comprises a second apparatus 2 for measurement of the solar radiation power G in the region of the photovoltaic modules 21, 22, 23, 24. The first apparatus 1 and the second apparatus 2 are physically directly associated with the photovoltaic unit 20 or are placed on or in the immediate vicinity of a photovoltaic module 21, 22, 23, 24.

The device 10 also comprises a third apparatus 3 for detecting current and voltage values for calculating the daily energy

E_{day}. The value E_{day} corresponds here to the total E according to FIG. 1 at 18:00. The third apparatus 3 comprises a direct voltage measuring device 3b for this purpose which detects the direct voltage at the inverter 25. The third apparatus also comprises four contactlessly operating direct current measuring devices 3a which are each associated with a DC input of the inverter 25 and which detect direct currents generated by the photovoltaic modules 21, 22, 23, 24. The values detected by the first apparatus 1, the second apparatus 2 and the third apparatus 3 are transmitted to a fourth apparatus 4 of the device 10. The fourth apparatus 4 is an arithmetic unit here in which the data required for calculating the temperature-compensated power ratio PR_{daycomp} are stored and measured values detected by means of the first apparatus 1, second apparatus 2 and third apparatus 3 are detected and processed. The calculations, which are required for determining the temperature-compensated power ratio PR_{daycomp}, are carried out by means of the arithmetic unit. The result of the calculations, i.e. the determination as to whether and optionally in which unit part of the photovoltaic unit 20 there is a defect, is output by way of example visually and/or acoustically via a warning signal. If the fourth apparatus 4 is not already capable of this the device 10 can optionally comprise a fifth apparatus 5 for outputting the warning signal.

Where a fourth apparatus 4 is present in the form of a PC and a fifth apparatus 5 in the form of a horn, a visual warning signal can be generated by way of example by means of the screen conventionally present with a PC and an acoustic warning signal can be generated by means of the horn. Like the first apparatus 1 and the second apparatus 2 already, the third apparatus 3 is directly associated with the photovoltaic unit 20. By contrast, the fourth apparatus 4 and optionally the fifth apparatus 5 of the photovoltaic unit 20 are often not directly associated but arranged at a greater distance therefrom in order to be able to carry out remote monitoring of the photovoltaic unit 20.

It is obvious that for functioning of the method or the device according to various embodiments it is irrelevant what size a photovoltaic unit is or which unit parts or which combination of unit parts are checked by means of the method or are equipped by means of the device. The method and device according to various embodiments can be used for a wide variety of photovoltaic units, by way of example having photovoltaic cells based on silicon or with an organic basis, in particular polymer basis. It is also unimportant how many photovoltaic modules, inverters, etc. there are.

In general a person skilled in the art can provide a connection of the photovoltaic unit to just one load or a plurality of loads or else to a public grid without departing from the basic idea of the invention.

What is claimed is:

1. A method for monitoring at least one unit part of a photovoltaic unit, comprising the following steps:
determining a temperature-compensated'daily solar radiation energy H_{daycomp} in Wh/m² of the at least one unit part, wherein
$${H}_{daycomp} = {\int }_{Sunrise}^{Sunset} G * ( 1 - ( T - 25 K ) * {γ}_{{P}_{MPP} ( T )} ) d t$$
where
G=solar radiation power in W/m²,
T=temperature of the at least one unit part in K,
γ_{P}_{_{MPP}}_{(T)}=temperature coefficient of at least one photovoltaic module of the at least one unit part in 1/K at maximal power,
determining a temperature-compensated power ratio PR_{daycomp} in %, wherein
$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$
where
E_{day}=daily energy of the at least one unit part in kWh,
Pₜₕₑₒ=maximum possible power in kW of the photovoltaic unit with standard test conditions, and
comparing the determined temperature-compensated power ratio PR_{daycomp} with a power ratio desired value for the at least one unit part.

2. The method according to claim 1, wherein the at least one unit part comprising at least one of: at least one photovoltaic module having a large number of photovoltaic cells and at least one inverter is chosen.

3. The method according to claim 1, wherein for determining the daily energy E_{day} a contactless direct current measurement is carried out and an instantaneous current signal determined in the process is multiplied by a direct voltage instantaneously measured at the at least one unit part.

4. The method according to claim 1, wherein the determination of the temperature-compensated power ratio PR_{daycomp} and the comparison between the determined temperature-compensated power ratio PR_{daycomp} and the power ratio desired value is automatically carried out for the at least one unit part.

5. The method according to claim 1, wherein the comparison between the determined temperature-compensated power ratio PR_{daycomp} and the power ratio desired value for the at least one unit part is only carried out if a fixed minimal value is attained or exceeded for H_{daycomp}.

6. The method according to claim 1, wherein at least one warning signal is output in the case of a negative deviation of the determined temperature-compensated power ratio PR_{daycomp} from the power ration desired value for the at least one unit part.

7. A device comprising:
at least one first apparatus for determining a temperature T of the at least one unit part, at least one second apparatus for determining a solar radiation power G in at least one unit part, at least one third apparatus for determining values for calculating a daily energy E_{day} of the at least one unit part, and
at least one fourth apparatus for at least one of calculating the daily energy E_{day} of the at least one unit part, for calculating a temperature-compensated daily solar radiation energy H_{daycomp} of the at least one unit part, for calculating a temperature-compensated power ratio PR_{daycomp} of the at least one unit part, and for comparing the temperature-compensated power ratio PR_{daycomp} with a power ratio desired value for the at least one unit part.

8. The device according to claim 7, wherein the at least one fourth apparatus is set up to carry out the following calculations:
determining the temperature-compensated daily solar radiation energy H_{daycomp} in Wh/m², wherein
$${H}_{daycomp} = {\int }_{Sunrise}^{Sunset} G * ( 1 - ( T - 25 K ) * {γ}_{{P}_{MPP} ( T )} ) d t$$
where
G=solar radiation power in W/m²,
T=temperature of the at least one unit part in K,
γ_{P}_{_{MPP}}_{(T)}=temperature coefficient in 1/K of at least one photovoltaic module of the at least one unit part at maximal power, and
determining a temperature-compensated power ratio PR_{daycomp} in %, wherein
$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$
where
E_{day}=daily energy of the at least one unit part in kWh,
Pₜₕₑₒ=maximum possible power in kW of the photovoltaic unit with standard test conditions, and
comparing the determined temperature-compensated power ratio PR_{daycomp} with a power ratio desired value for the at least one unit part.

9. The device according to claim 7, wherein furthermore there is at least one fifth apparatus for outputting at least one warning signal in the case of a negative deviation of the determined temperature-compensated power ratio PR_{daycomp} from the power ratio desired value.

10. The device according to claim 7, wherein the at least one first apparatus and the at least one second apparatus are associated with the photovoltaic unit.

11. The device according to claim 7, wherein a third apparatus respectively for determining values for calculating a daily energy E_{day} are associated with an inverter of the photovoltaic unit.

12. The device according to claim 7, wherein the at least one fourth apparatus is provided by at least one arithmetic unit.

13. The device according to claim 7, wherein remote monitoring of the photovoltaic unit can be carried out by means of at least one of the at least one fourth device and the at least one fifth apparatus.

14. The device according to claim 7, wherein at least one of the first and second apparatus(es) are installed at two or more points of the photovoltaic unit for monitoring a photovoltaic unit with a power in the region of several megawatts.

15. A method for detecting at least one defect in at least one unit part of a photovoltaic unit or an entire photovoltaic unit, comprising:
using a device comprising:
at least one first apparatus for determining a temperature T of the at least one unit part,
at least one second apparatus for determining a solar radiation power G in at least one unit part,
at least one third apparatus for determining values for calculating a daily energy E_{day} of the at least one unit part, and
at least one fourth apparatus for at least one of calculating the daily energy E_{day} of the at least one unit part, for calculating a temperature-compensated daily solar radiation energy H_{daycomp} of the at least one unit part, for calculating a temperature-compensated power ratio PR_{daycomp} of the at least one unit part, and for comparing the temperature-compensated power ratio PR_{daycomp} with a power ratio desired value for the at least one unit part,
wherein the method comprising the steps of:
determining a temperature-compensated daily solar radiation energy H_{daycomp} in Wh/m² of the at least one unit part, wherein
$${H}_{daycomp} = {\int }_{Sunrise}^{Sunset} G * ( 1 - ( T - 25 K ) * {γ}_{{P}_{MPP} ( T )} ) d t$$
where
G=solar radiation power in W/m²,
T=temperature of the at least one unit part in K,
_{P}_{_{MPP}}_{(T)}=temperature coefficient of at least one photovoltaic module of the at least one unit part in 1/K at maximal power,
determining a temperature-compensated power ratio PR_{daycomp} in %, wherein
$${PR}_{daycomp} = \frac{( \frac{{E}_{day}}{{P}_{theo}} )}{( \frac{{H}_{daycomp}}{1000 \frac{W}{{m}^{2}}} )} * 100 \% ,$$
where
E_{day}=daily energy of the at least one unit part in kWh,
Pₜₕₑₒ=maximum possible power in kW of the photovoltaic unit with standard test conditions, and
comparing the determined temperature-compensated power ratio PR_{daycomp} with a power ratio desired value for the at least one unit part.

16. The method according to claim 15, wherein the at least one unit part comprising at least one of: at least one photovoltaic module having a large number of photovoltaic cells and at least one inverter is chosen.

17. The method according to claim 15, wherein for determining the daily energy E_{day} a contactless direct current measurement is carried out and an instantaneous current signal determined in the process is multiplied by a direct voltage instantaneously measured at the at least one unit part.

18. The method according to claim 15, wherein the determination of the temperature-compensated power ratio PR_{daycomp} and the comparison between the determined temperature-compensated power ratio PR_{daycomp} and the power ratio desired value is automatically carried out for the at least one unit part.

19. The method according to claim 15, wherein the comparison between the determined temperature-compensated power ratio PR_{daycomp} and the power ratio desired value for the at least one unit part is only carried out if a fixed minimal value is attained or exceeded for H_{daycomp}.

20. The method according to claim 15, wherein at least one warning signal is output in the case of a negative deviation of the determined temperature-compensated power ratio PR_{daycomp} from the power ration desired value for the at least one unit part.
